(19) United States
(12) Patent Application Publication
(10) Pub. No.: US 2009/0040111 A1
(43) Pub. Date: Feb. 12, 2009

(54) Antenna System for a Radar Sensor

(76) Inventors: Ewald Schmidt, Ludwigsburg (DE); Juergen Hasch, Stuttgart (DE)

Correspondence Address: KENYON & KENYON LLP, ONE BROADWAY, NEW YORK, NY, 10004, US

(21) Appl. No.: 12/085,409

(22) PCT Filed: Nov. 9, 2006
(86) PCT No.: PCT/EP2006/068309

§ 371 Date: May 21, 2008

(30) Foreign Application Priority Data
Nov. 29, 2005 (DE) 102005056756.8

(51) Int. Cl. H01Q 9/04; G01S 13/93

(52) U.S. Cl. 343/700 MS; 342/175

(57) ABSTRACT

An antenna system for a radar sensor, in particular for ascertaining distance and/or speed in the surroundings of motor vehicles, at least one part of an antenna being situated on a chip which includes at least a portion of the transceiver units of the radar sensor, and at least one second radiation-coupled part which is situated at a distance from the first part over the chip; the first part includes at least one exciter/receiver element which is part of a semiconductor element forming the chip, and the second part is a resonator element which is situated on a support and has a surface which is larger than the surface of the exciter element.

### FIELD OF THE INVENTION

The present invention relates to an antenna system for a radar sensor, in particular for ascertaining distance and/or speed. Radar sensors which include this special antenna system have a very wide range of possible applications. In particular, adapted designs in the very close centimeter range, such as for determining drilling depth, or in the meter range, such as in the surroundings of motor vehicles, are used.

### BACKGROUND INFORMATION

Radar sensors of this type, i.e., transceiver modules, are used in the microwave and millimeter wave range for locating objects in space or for determining speed, in particular the speed of motor vehicles. Radar sensors of this type are used, in particular, for driver assistance systems, which are used, for example, to determine the distance between one vehicle and another preceding vehicle and to regulate the distance. To locate objects in space and to determine speed, a radar sensor of this type transmits super high frequency signals in the form of electromagnetic waves which are reflected from the target object and are received again by the radar sensor and further processed. It is not unusual for a plurality of these radar sensors to be interconnected to form an overall module.

A radar sensor for microwave and millimeter wave applications is described in German Patent Application No. DE 103 00 955, in which both transceiver units and an antenna are situated on a structural element having a multilayer design. A layer structure of this type requires connections which must be designed in such a way that super high frequency RF signals are transmittable. To be able to produce such RF transitions in a relatively low-loss manner, the manufacture of these radar sensors must meet very strict requirements.

An antenna system for a radar sensor is described in the not previously published German Patent No. DE 10 2004 059 333.7, in which the at least one antenna includes a first part situated on the chip and a second part which is situated at a distance from the first part and is radiation-coupled to the first part.

In this antenna system, it is provided that an antenna system which uses printed parallel-fed dipoles, i.e., a differential feed line, instead of patch antennas, is situated on the chip, which has very thin electrically active layers, which also include the transceiver units. Dividing the antenna into a first part situated on the chip and a second part which is situated at a distance from the first chip and is radiation-coupled to the first chip enables the bandwidth to be advantageously increased. The radiation resistance is also reduced. The second part of the antenna is preferably situated on a radome.

An antenna system is described in the likewise not previously published German Patent No. DE 10 2004 063 541.2, in which the second part of the antenna is situated on an antenna support or an additional chip which is attached over the first part by a special mounting and contacting process to achieve low mechanical tolerances. Attachment in this case is by flip-chip connections. The cost of the radar sensor is substantially reduced by integrating all radio-frequency components on the semiconductor chip, in particular modules such as the oscillator, mixer, and amplifier. Moreover, the passive modules are also integrated on the semiconductor component.

Different approaches for integrating antenna elements on semiconductor circuits are known. For example, high-resistance silicon wafers are used in which antenna structures are manufactured by micromechanical reworking such as back thinning or etching of layers. Moreover, the deposition of an addition layer, made for example from BCB (benzocyclobutene), on which an antenna element is applied, may be provided.

The problem with this method is that the manufacture of the antennas requires additional technology steps for processing the silicon wafer.

An object of the present invention is therefore to provide an antenna system for emitting electromagnetic waves which includes a defined radiation characteristic having very narrow tolerances in series production at a good level of efficiency. It must be possible to manufacture this antenna system economically, and additional processing steps in the manufacture of the semiconductor circuits must be avoided.

### SUMMARY OF THE INVENTION

This object is achieved by an antenna system for a radar sensor according to the present invention. In addition to simple manufacture which requires no additional process steps for manufacturing the semiconductor circuits, an antenna system of this type is relatively independent of the back-end process, i.e., the formation of the metal layers in the semiconductor process. This back-end process mainly influences only the antenna's efficiency.

In a suitable back-end process having relatively great distances between the bottom and top metal layers in the range of approximately 10 μm, an antenna efficiency of well above 50% is achievable. An antenna system according to the present invention also allows for a defined and well-formed directional diagram having few side lobes. The fact that radio-frequency-compatible electrical transitions from the RF semiconductor element to a printed circuit board substrate are not required is extremely advantageous and economical. This enables the electrical connections of the supply and information lines of the semiconductor circuit to be implemented by standardized bond wiring, since the antenna beam direction is aimed upward, away from the chip. The printed circuit board substrate may be made from the most economical polyester material (FR4).

The first part is preferably asymmetrically contacted and is formed by a shortened rectangular patch element which is short-circuited at one end. The second part includes a rectangular resonator whose center is positioned over an open edge of the first part on the support.

According to an advantageous specific embodiment, therefore, the exciter element is a mainly flat metallic surface, known as an exciter patch.

This exciter patch has a length which preferably mainly corresponds to one quarter of the wavelength to be emitted, and a width which is shorter than the length.

The resonator element is a metallic surface of a mainly flat design on the support, known as a resonator patch. This resonator patch has a length which mainly corresponds to one half the wavelength of the emitted electromagnetic radiation, and a width which is shorter than the length.

The resonator element may include a polyrod, i.e., a tapered cylinder for forming the beam, which enables a higher antenna gain to be achieved.

To protect the antenna system against environmental influences, there may be a further provision to introduce into the space between the chip and the support through the exciter patch and the resonator patch a filling sealing compound.

### BRIEF DESCRIPTION OF THE DRAWINGS

FIGS. 1a and 1b show a schematic representation of an exciter element situated on a chip according to the present invention.

FIG. 2 shows a cross-sectional view of the exciter element illustrated in FIG. 1 having a resonator element situated thereover.

FIG. 3 shows the electrical lines of force of the antenna system illustrated in FIG. 2.

FIG. 4 shows a schematic representation of an antenna system including an additional polyrod.

### DETAILED DESCRIPTION

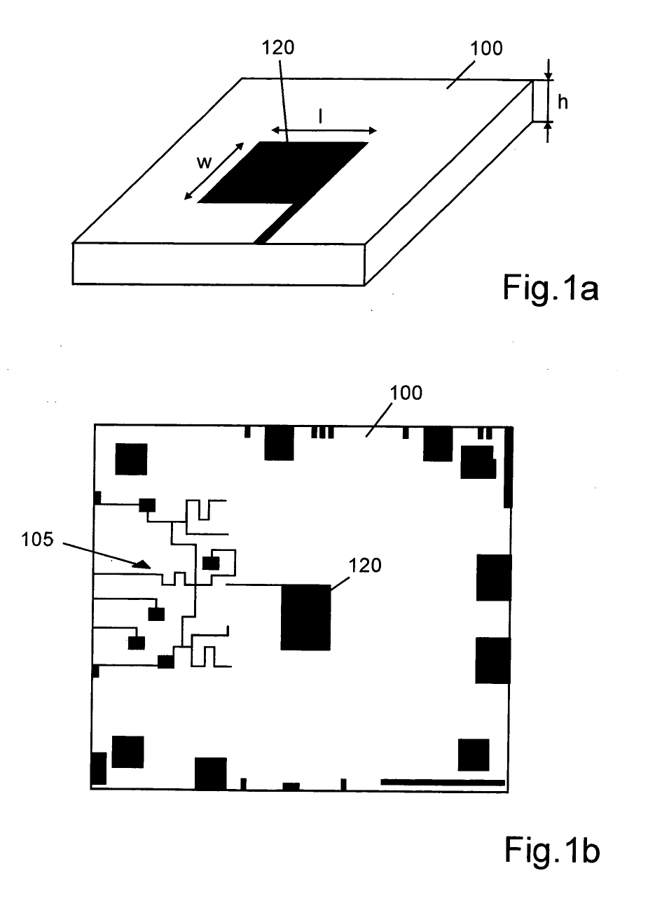

In a radar sensor illustrated in FIGS. 1a and 1b, not only are all transceiver units 105 of the transceiver situated on a chip 100, but also an exciter/receiver element 120 of the antenna system. Chip 100 includes, for example, a semiconductor element which has a defined dielectric constant. As shown in particular in FIG. 1a, the exciter element is formed by a shortened rectangular patch element which is short-circuited at one end and contacted asymmetrically.

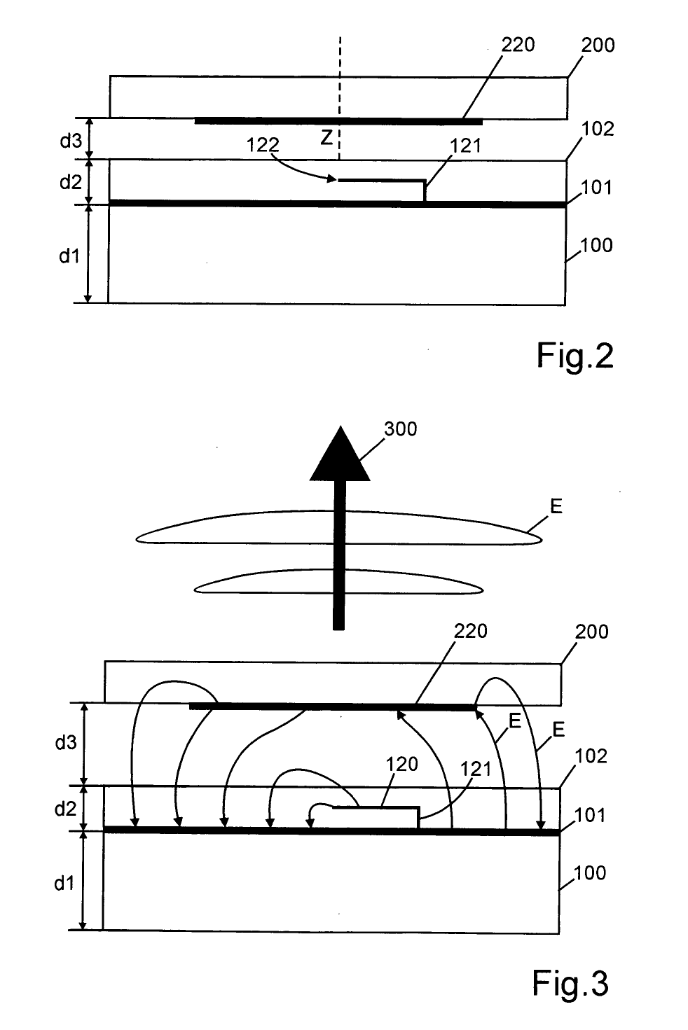

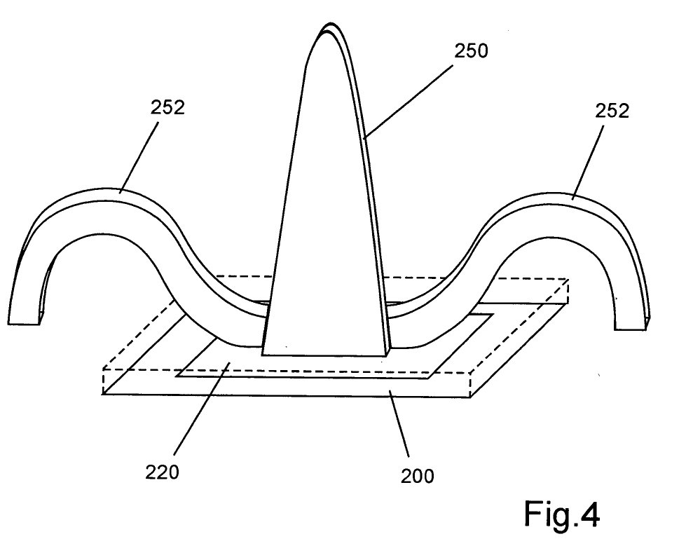

FIGS. 2 and 3 show a cross-sectional representation of an antenna system of this type. An oxide layer 102, into which exciter/receiver element 120 is embedded, is provided on silicon chip 100.

Exciter/receiver element 120, which is also referred to as an exciter patch, includes a mainly flat metallic surface having a length l and a width w (refer to FIG. 1a). It is short-circuited to a metallic layer 101 of the chip via a ridge 121 (refer to FIGS. 2 and 3). Exciter/receiver patch 120 has a length which preferably mainly corresponds to one quarter of the wavelength to be emitted, and a width which is shorter than the length.

Chip 100 itself may have a thickness d1 of approximately 350 μm, and the oxide layer has a thickness d2 of 9 μm (FIGS. 2 and 3).

Situated over exciter/receiver patch 120 is a resonator element 220 which is formed by a likewise mainly flat metallic surface which is situated on a support 200. Support 200 is made of plastic, and the flat metallic surface of resonator element 220, also referred to as resonator patch 220, is situated at a distance d3 of approximately 150 μm over oxide layer 102 (FIGS. 2 and 3). Resonator patch 220 has a length which mainly corresponds to one half the wavelength of the emitted electromagnetic radiation, and a width which is shorter than the length. The center of rectangular resonator patch 220, illustrated in FIG. 2 by a line designated Z, is located over an open edge 122 of exciter/receiver element 120.

The lines of force of electromagnetic field E are illustrated schematically in FIG. 3, and the propagation of field E is indicated by an arrow 300. Field E mainly propagates away from the antenna system, directed upward, which is why the entire chip is contactable by bond wires, which are known per se.

To form the beam, a so-called polyrod 250 may be situated over resonator patch 220, i.e., a cone-shaped structure for forming the beam which is supported on chip 100 by side arms 252.

In an advantageous specific embodiment, the space between chip 100 and support 200 is fillable by a sealing compound, in particular a silicon gel or an epoxy resin-based underfiller, which embeds exciter/receiver patch 120 and resonator patch 220.

1-8. (canceled)

9. An antenna system for a radar sensor comprising:
at least one first part of an antenna situated on a chip which includes at least a portion of transceiver units of the radar sensor, the first part including at least one exciter/receiver element which is part of a semiconductor element forming the chip; and
at least one second radiation-coupled part situated at a distance from the first part over the chip, the second part including a resonator element which is situated on a support and has a surface which is larger than a surface of the exciter/receiver element.

10. The antenna system according to claim 9, wherein the antenna system is for ascertaining at least one of distance and speed in surroundings of a motor vehicle.

11. The antenna system according to claim 9, wherein the exciter/receiver element is asymmetrically contacted and formed by a rectangular patch element which is short-circuited at one end, and the resonator element is a rectangular resonator whose center is situated substantially over an open edge of the rectangular patch element on the support.

12. The antenna system according to claim 9, wherein the exciter/receiver element is an exciter/receiver patch having a substantially flat metallic surface.

13. The antenna system according to claim 12, wherein the exciter/receiver patch has a length which substantially corresponds to one quarter of a wavelength to be emitted, and a width which is shorter than the length.

14. The antenna system according to claim 9, wherein the resonator element is a resonator patch having a metallic surface of a substantially flat design on the support.

15. The antenna system according to claim 14, wherein the resonator patch has a length which substantially corresponds to half a wavelength of emitted electromagnetic radiation, and a width which is about half the length.

16. The antenna system according to claim 9, wherein the resonator element is attached under a polyrod, placed in a defined manner over the semiconductor element.

17. The antenna system according to claim 9, wherein a space between the chip and the support is filled by a sealing compound, including silicon gel or epoxy resin-based underfiller, which embeds the exciter/receiver element and the resonator element.
